(19) United States
(12) Patent Application Publication
(10) Pub. No.: US 2008/0208765 A1
(43) Pub. Date: Aug. 28, 2008

(54) METHOD AND APPARATUS FOR COMPARISON OF VARIABLE TERM FINANCIAL INSTRUMENTS USING LIFE EXTENSION DURATION COMPUTATION

(76) Inventors: Anne Zissu, Philadelphia, PA (US); Charles A. Stone, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/680,088

(22) Filed: Feb. 28, 2007

(51) Int. Cl. G06Q 40/00

(52) U.S. Cl. 705/36 R

(57) ABSTRACT

A method of evaluating a variable term security including assessing life extension risk of the variable term security due to a deviation from nominal life expectancy of the variable term security, computing a summary factor of said life extension risk, and comparing the summary factor of said life extension risk to a predetermined criterion and thereby evaluating the variable term security.

### BACKGROUND OF THE INVENTION

1. Field of Invention

This invention relates to evaluation of financial instruments, in particular to evaluation of the instruments with known cash flows occurring regularly for an uncertain number of periods.

2. Description of Prior Art

The liquidity of capital markets depends to some extent upon the existence of conventions for concise expression of complex deal terms. In the bond market, for instance, traders can evaluate alternative investment opportunities by looking at a summary risk factor for each bond called the modified duration. This factor gives the ratio of the percentage change in the value of a bond per change in the value of the prevailing interest rate. As such, it is a factor that expresses a summary of the risk in the investment.

Of course today, using computers, it is relatively easy to model and simulate bond value fluctuations given clear and complete clear information on the payment terms of the bond by using assumptions about future interest rate movement. However, being able to perform such computations in a timely manner presupposes both ready access to such information and ease in modifying model programming in accordance with the bewildering array of covenant variations. Such is often impractical. Traders, electronic trading billboards, newspapers, and automated systems instead often rely upon the modified duration factor as a proxy expression or in other words a summary interest rate risk factor of the bond.

U.S. Pat. No. 6,999,935 to Parankirinathan describes a method for insuring against the adverse financial consequences of survival risk to a third party and a means for calculating the premium for said insurance.

U.S. Patent Application No. 20040064391 to Lange provides methods and systems for securitization and risk management of life settlement contracts.

Until recently, no analogous summary risk factor existed to express the life extension risk of securities backed by senior life settlements. A senior life settlement is a contract that transfers a life insurance policy from the insured (the life settler) to a life settlement company. The life settler gets cash, typically then used to pay for retirement or medical needs. The settlement company becomes responsible for continuing to pay premiums on the policy, and in the end is the beneficiary of the insurance policy when the life settler passes away.

The value of a life settlement contract is based on the life expectancy of the settler. Life expectancy is a function of settler's age and health condition. If a settler lives longer than the life expectancy, i.e. there is a positive life extension, the settlement company must pay policy premiums longer and also wait longer to receive the death benefit. Thus, in addition to inflation risk, interest rate risk and default risk, life settlement companies face life extension risk in life settlement contracts.

Life settlement companies raise money to pay life settlers by offering financial securities backed by pools of life settlement contracts. Today, potential investors in these securities are often provided lengthy prospectus information which may include the total anticipated death benefit, the weighted average life expectancy of the life settlers, and the distribution of ages or medical conditions of the life settlers. Needless to say, modeling and computing the risks of investing in such a security is more complex than doing so for ordinary bonds. Further, the risk of each pool exhibits a unique risk dependent upon the distribution of life expectancies, ages, and medical conditions of the life settlers involved. This makes direct comparison of alternative security offerings based on life settlement pools extremely difficult at best. This difficulty leads to a less liquid market for capital for life settlement companies, which may result in less competition among settlement companies, and ultimately lead to lower payments to senior citizens who become life settlers.

Despite the foregoing developments, it is desired to provide methods of evaluating risks of variable term securities.

All references cited herein are incorporated herein by reference in their entireties.

### BRIEF SUMMARY OF THE INVENTION

In a first aspect, the invention comprises a method of evaluating a variable term security which includes:

assessing life extension risk of the variable term security due to a deviation from nominal life expectancy of the variable term security;

computing a summary factor of said life extension risk; and

comparing the summary factor of said life extension risk to a predetermined criterion and thereby evaluating the variable term security.

In certain embodiments, the summary factor of the life extension risk is at least one of a life extension duration, a modified life extension duration, or a life extension convexity.

In certain embodiments, the method further includes obtaining the nominal life expectancy of the variable term security (t), obtaining a periodic premium of the variable term security (P), obtaining a terminal benefit of the variable term security (B), obtaining a prevailing interest rate (r), and setting a compounding factor (a) according to the formula:

a=1/(1+r).

In certain embodiments, the method includes computing the life extension duration by applying the formula:

life extension duration={t*a^{t}*(P+(r*B)*ln(a)}/{(a^{t}*(P+(r*B)))−P}.

In certain embodiments, the method includes computing the change in the value of a variable term security by multiplying the life extension duration by the deviation from life expectancy (Δt).

In certain embodiments, the method includes computing the modified life extension duration by applying the formula:

modified life extension duration={a^{t}*(P+(r*B))*ln(a)}/{(a^{t}*(P+(r*B)))−P}.

In certain embodiments, the method includes computing the life extension convexity according to the formula:

life extension convexity={((P/r)+B)*(a^{t})*((ln(a))²)}/{(a^{t}*((P/r)+B))−(P/r)}.

In certain embodiments, the method includes deciding to trade or not to trade the variable term security based at least in part upon a comparison of the summary factor of life extension risk to the predetermined criterion.

In certain embodiments, the method includes computing an aggregate factor of life extension risk for the plurality of variable term securities by aggregating the summary factor of life extension risk of each variable term security. In certain variants of these embodiments, the aggregate factor of the life extension risk is at least one of a weighted average life extension duration, a weighted average modified life extension duration, or a weighted average life extension convexity.

In certain embodiments, the method further includes obtaining the nominal life expectancy of each variable term security (t), obtaining the periodic premium of the each variable term security (P), obtaining the terminal benefit of the each variable term security (B), obtaining the prevailing interest rate (r), setting the compounding factor a=1/(1+r), computing the nominal value of the variable term security (V(sls)) according to the formula: V(sls)={a^{t}*((P/r)+B)}−(P/r), and computing the nominal value of a pool of (n) variable term securities (V(pool)) according to the formula:

$${\sum }_{i = 1}^{n} ( {V ( sls )}_{i}$$

wherein n is a number of variable term securities.

In certain embodiments, the method includes computing the weighted average modified life extension duration for the plurality of variable term securities according to the formula:

$${\sum }_{i = 1}^{n} ( {V ( sls )}_{i} / V ( pool ) ) * {( modified life extension duration )}_{i}$$

wherein n is a number of variable term securities.

In certain embodiments, the method includes computing the weighted average life extension convexity for the plurality of variable term securities according to the formula:

$${\sum }_{i = 1}^{n} ( {V ( sls )}_{i} / V ( pool ) ) * {( life extension convexity )}_{i}$$

wherein n is a number of variable term securities.

In a second aspect, the invention comprises a system for computing and displaying a method of evaluating a variable term security or a plurality of variable term securities which includes:

a computer having a memory and a processor, wherein the memory comprises an algorithm for calculation of a summary factor of life extension risk of a variable term security or an aggregate factor of life extension risk of a plurality of variable term securities;

a monitor display in communication with the computer for dynamically displaying one or more summary factors of life extension risk or aggregate factors of life extension risk; and

an input in communication with the computer for inputting variables related to the variable term security or plurality of variable term securities.

In a third aspect, the invention comprises a system for electronic trading of variable term securities, the system comprising a plurality of computer terminals and a data network or data networks, wherein the plurality of computer terminals are in communication with the data network or data networks, and wherein the plurality of computer terminals are adapted to display at least one of (i) a summary factor of life extension risk or an aggregate factor of life extension risk of the variable term securities, (ii) comparison of the summary factor or aggregate factors to a predetermined criterion, and (iii) the result of a comparison of the summary factor or aggregate factors to a predetermined criterion.

In a fourth aspect, the invention comprises a system for automatic electronic trading of variable term securities, the system comprising:

a trade execution mechanism and a computer, the computer comprising a processor and a memory, the memory comprising;

a summary factor of life extension risk or aggregate factor of life extension risk;

an investor criterion for selecting a variable term security or plurality of variable term securities; and

an algorithm for deciding to trade or not to trade a variable term security or a plurality of variable term securities based at least in part on comparison of the summary factor of life extension risk or the aggregate factor of life extension risk to the investor criterion.

### BRIEF DESCRIPTION OF SEVERAL VIEWS OF THE DRAWINGS

FIG. 1. is a flow chart depicting a method by which an investment decisions may be reached in an automated fashion for a variable term security such as a senior life settlement.

FIG. 2. is a flow chart depicting a method of selecting plural variable term securities to be pooled together in an investment offering.

FIG. 3. is a flow chart depicting a method for aggregating the summary factors life extension risk of a pool of variable term securities.

FIG. 4. is a flow chart depicting a method for utilizing aggregated factors of life extension risk in assessing pools of variable term securities and of reaching investment decisions there appertaining.

FIG. 5 is a graph depicting three curves reflecting the change in value of a variable term security with change in interest rate. One curve depicts the value at the nominal life expectancy. A second curve depicts the value recomputed using Equation 1 when there is a life extension of +2. The third curve depicts the value estimated using summary factors of life extension risk when there is a life extension of +2.

FIG. 6 is a graph depicting three curves reflecting three values for each of thirteen variable term securities respectively. The first curve depicts the value of each variable term security at the nominal life expectancy of the variable term security. The second curve depicts the value recomputed using Equation 1 when there is a life extension of +2. The third curve depicts the value estimated using summary factors of life extension risk when there is a life extension of +2.

### DETAILED DESCRIPTION OF PREFERRED EMBODIMENTS OF THE INVENTION

Preferred embodiments of the invention are directed to method of evaluating a variable term security including assessing life extension risk of the variable term security due to a deviation from nominal life expectancy of the variable term security; computing a summary factor of said life extension risk; and comparing the summary factor of said life extension risk to a predetermined criterion and thereby evaluating the variable term security.

Surprisingly, the inventors have found that evaluating a variable term security can be performed based on a variety of summary risk factors, such as of a life extension duration, a modified life extension duration, a life extension convexity, or a combination thereof.

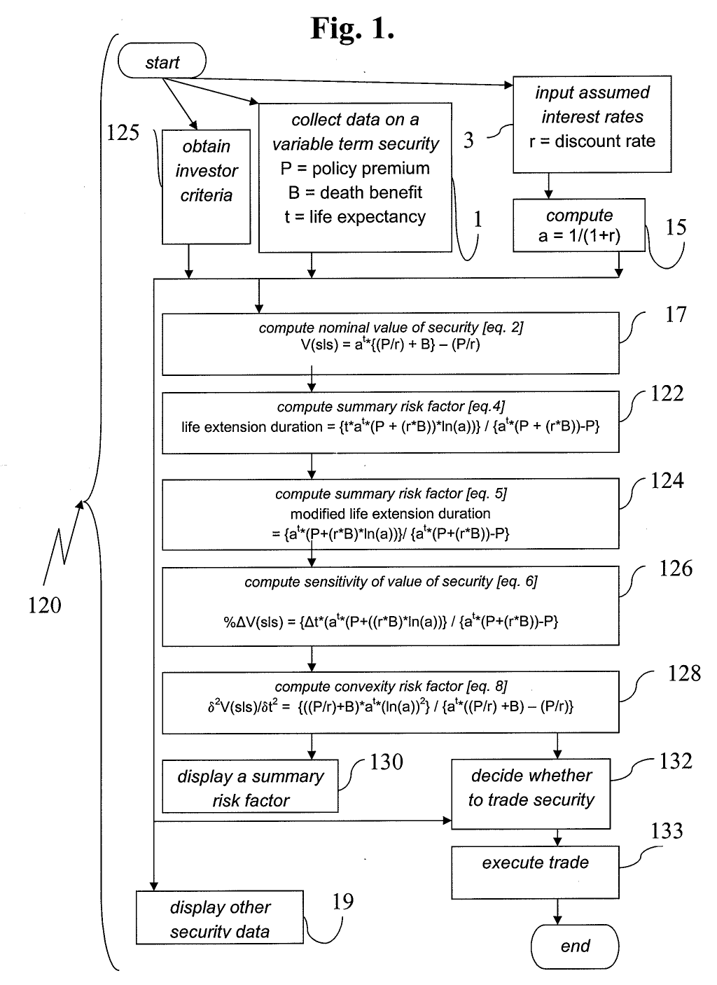

Referring now to FIG. 1, in the life extension risk assessment process 120, term information 1 about the variable term security are obtained, including nominal life expectancy (t), the periodic premium (P), and the terminal benefit of the variable term security (B). Such data may be obtained by electronic data storage retrieval or user input. Rate information 3 is obtained about the assumed prevailing interest rate (r). For convenience, r maybe converted in a separate calculation 15 to provide a compounding factor (a).

A variety of computations may now be performed, including computation of the nominal value 17 of the variable term security according to Equation 2, the life extension duration 122 according to Equation 4, modified life extension duration 124 according to equation 5, life extension convexity 126 according to Equation 6, and life extension curvature 128 according to Equation 8.

In a preferred embodiment of the invention, one or more of the summary factors of life extension risk 122, 124, 126, or 128 is then displayed on a display 130 in at least one medium useful to financial markets, including, put not limited to, electronic trading and billboard systems, electronic data exchange systems, newspapers, Internet web sites, or telecommunications network dispatch. The display 130 may be accompanied by other data 19 regarding the variable term security.

Another preferred embodiment of invention includes deciding 132 to trade or not to trade the variable term security based at least in part upon a comparison of computed a summary factor of life extension risk 122, 124, 126, or 128 to a predetermined investor 125 criterion. In an alternative embodiment the trade may then be executed through an automated mechanism 133.

In yet another preferred embodiment of the invention, a financial institution or an investor will find it useful to know the life extension duration and life extension convexity of many variable term securities in order to construct pools of such variable term securities exhibiting particular risk characteristics. For example, a life settlement company that is buying life settlement contracts will find it useful to know the life extension duration and life extension convexity of each contract so its structure of liabilities can be properly managed and matched to its asset structure, the senior life settlement contracts. The administrator of the pool will be able to target a weighted average life extension duration and weighted average life extension convexity for the life settlement pool that is being accumulated and adjust purchases to approach the targets.

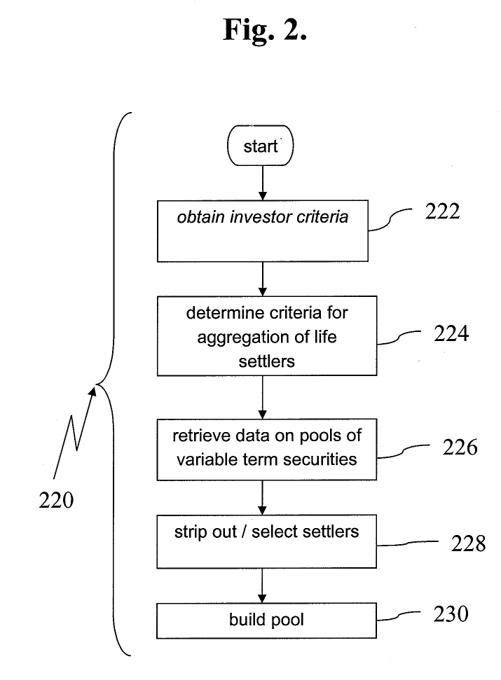

FIG. 2 depicts a process 220 whereby a pool of variable term securities is constructed. First, one or more criteria of a potential investor is obtained 222. The criteria may include aggregate factors of life extension risk. For example, if a life settlement company that has accumulated a pool of life settlement contracts and now seeks to refinance the pool in the capital markets, the company will need to offer prospective investors information that can be used to compare investments to other opportunities in the life settlement market and to investments in other segments of the fixed income market. A pool with a weighted average life extension duration of −2 is not equivalent to a life-settlement pool with a weighted average life extension duration of −2.8. The value of a pool with a weighted average life extension convexity of 0.9 is less sensitive to deviations of the pool's actual life from life expectancy than a pool with a weighted average life extension convexity of 1.3. The ability of an investor to make investment decisions that are guided by summary measures such as weighted average life extension duration and weighted average life extension convexity will lead to more rational investment decisions and more consistent pricing. The investor criteria 222 can be used to determine selection criteria 224, which can then be compared to existing pools 226 of variable term securities for inclusion. Individual or collections of variable term securities meeting the criteria can then be added or removed from the pool as needed 228, and the final pool determined 230.

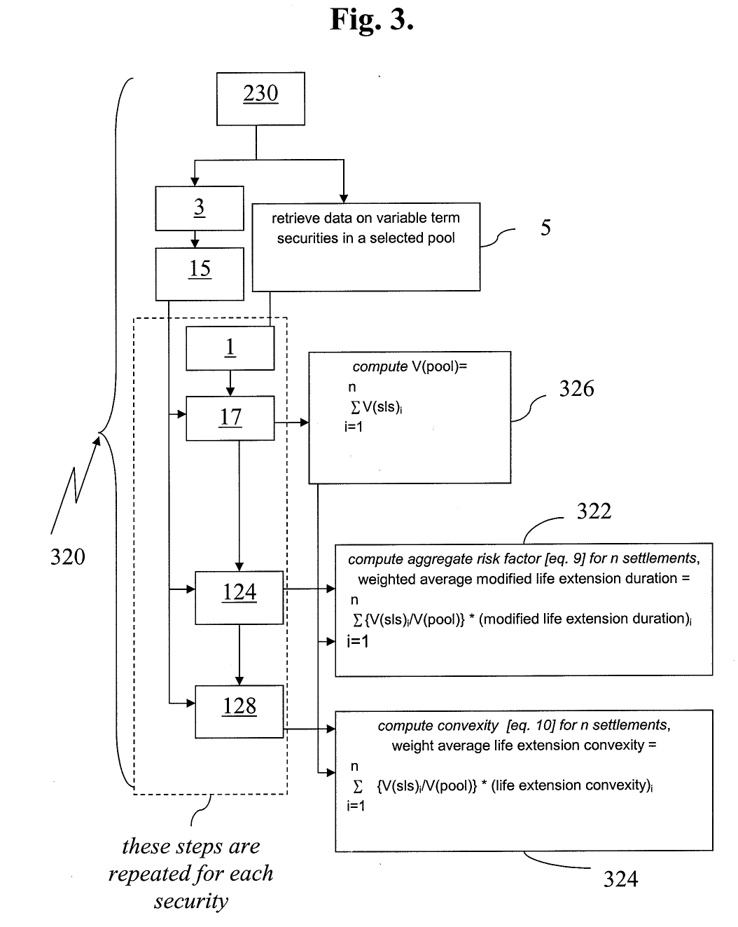

FIG. 3 depicts a process 320 for determining the aggregate factors of life extension risk for a pool of variable term securities. Once a pool has been selected 230, information pertinent to the pool 5 is obtained. Then, summary factors of the life extension risk of each variable term security in the pool are computed as required if not already available in information 5. This would be done by obtaining rate information 3 and computing the compounding factor 15, and then for each variable term security obtaining the term data 1, computing the value 17, computing the modified life extension duration 124 and optionally the life extension convexity 128. The nominal value of the pool is then summed 326, and this data used to obtain the weighted average modified life extension duration 322 according to Equation 9, and, optionally, the weighted average life extension convexity 324 according to Equation 10.

Once the weighted average life extension duration and weighted average life extension convexity become established metrics, investors should see a correlation between higher absolute weighted average life extension durations and weighted average life extension convexities and yield. Using these metrics will enable investors to trade off yield against reductions in longevity risk or trade increases in longevity risk for higher yield.

The print and electronic media such as the Wall Street Journal and Bloomberg plc, respectively, will be able to supply investors with the yield weighted average life extension duration and weighted average life extension convexity combinations so investors and potential investors can keep tabs on the value of life settlement pools. Speculators and traders will be able to short weighted average life extension convexity and/or take long positions in weighted average life extension duration depending upon their outlook on interest rate and the longevity expectations.

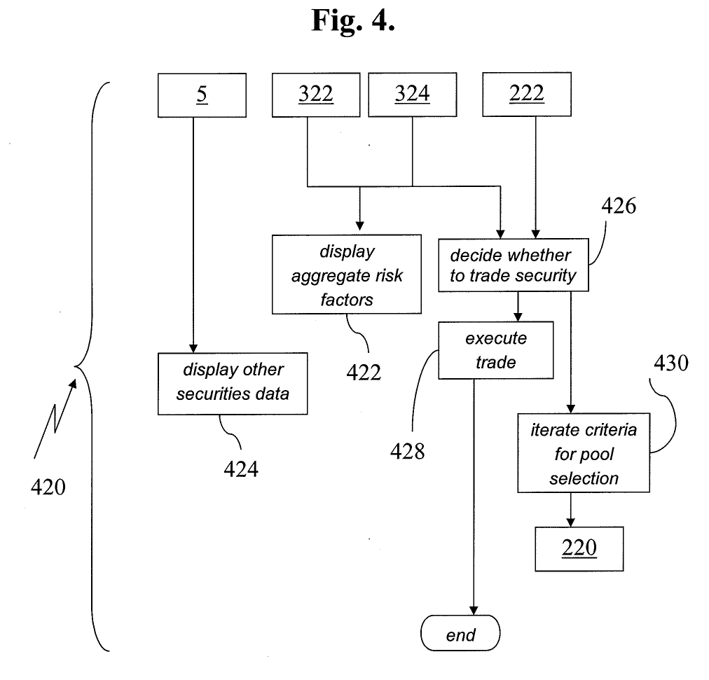

FIG. 4 depicts a process 420 for trading pools of variable term securities. In a preferred embodiment of the invention, one or more of the aggregate factors of life extension risk 322 and 324 is displayed 422 in at least one medium useful to financial markets, including, put not limited to, electronic trading and billboard systems, electronic data exchange systems, newspapers, Internet web sites, or telecommunications network dispatch. The display 422 may be accompanied by other data 424 regarding the pool of variable term securities or individual variable term securities. The other data 424 may include summary factors of life extension risk 122, 124, 126, 128 of individual variable term securities.

Another preferred embodiment of invention includes deciding 426 to trade or not to trade the variable term security based at least in part upon a comparison of computed a aggregate factor of life extension risk 322 or 324, to a predetermined investor criterion 222. In an alternative embodiment the trade may then be executed through an automated mechanism 428. Alternatively, the decision 426 can be use to trigger iteration of pool selection criteria 430 and restart the pool creation process 220.

### DEFINITIONS OF TERMS

The term “variable term security” as used herein means a financial contract with defined cash flows continuing for an uncertain number of periods. Non-limiting examples of variable term securities include a life insurance policy with annual premiums due for an uncertain number of years in exchange for a defined final benefit, a life settlement contract secured by a life insurance policy, a viatical, and other similar financial contracts.

The term “nominal life expectancy” as used herein means probable term of a variable term security. For example, in the case of a senior life settlement, the nominal life expectancy would be the number of years that the life settler is expected to survive after the execution of the life settlement contract. In this case nominal life expectancy is typically derived from actuarial tables given the life settler's age and medical condition.

The term “life extension risk” as used herein means the possibility that the term of a variable term security will deviate from the nominal life expectancy, thereby altering the number and timing of cash flows.

The term “summary factor of life extension risk” as used herein means a variable numerical factor which may be multiplied by the deviation from nominal life expectancy to estimate the impact of the deviation on the value of the variable term security.

The life extension duration is the ratio of the change in the ultimate value of a variable term security for given change in life expectancy at a given point of nominal life expectancy. For example, the units of life extension duration might be Δ$/ΔT.

The modified life extension duration expresses the sensitivity of the value (percentage change of the value) of a variable term security to variations in the actual length of a settler's life versus his or her life expectancy at the time the life settlement contract is executed. For example, the units of modified life extension duration might be % Δ$/% Δt.

The life extension convexity is the rate of change of the modified-life extension duration. For example, the units of the life extension convexity might be {(% Δ$/% Δt)/Δt)}.

A predetermined criterion can be any criterion, which is selected by a user (e.g. an investor.) Non-limiting examples of predetermined criterions include threshold values of summary factors of life extension risk, e.g. a criterion that the modified life extension duration be equal to, or greater than, negative 1.5.

The inventors also provide similar factors for a pool of such settlements, such as aggregate factor of the life extension risk, weighted average life extension duration, weighted average modified life extension duration, and weighted average life extension convexity.

The term “aggregate factor of the life extension risk” as used herein means a variable numerical factor which may be multiplied by the deviation from nominal life expectancy to estimate the impact of the deviation on the value of an aggregated pool of variable term securities.

The term “weighted average life extension duration” as used herein means an aggregate factor of life extension risk derived by summing the products of the life extension duration of each variable term security in a pool of variable term securities times the ratio of the value of the variable term security to the sum of the values of the variable term securities in the pool. For example, the units of the weighted average life extension duration might be Δ$/ΔT.

The term “weighted average modified life extension duration” as used herein means an aggregate factor of life extension risk derived by summing the products of the life modified extension duration of each variable term security in a pool of variable term securities times the ratio of the value of the variable term security to the sum of the values of the variable term securities in the pool. For example, the units of the weighted average modified life extension duration might be % Δ$/% Δt.

The term “weighted average life extension convexity” as used herein means an aggregate factor of life extension risk derived by summing the products of the life extension convexity of each variable term security in a pool of variable term securities times the ratio of the value of the variable term security to the sum of the values of the variable term securities in the pool. For example, the units of the weighted average life extension convexity might be (% Δ$/% Δt)/ΔT.

The derivation of the life extension duration is as follows. The valuation of a senior life settlement, V(sls), is obtained by discounting the premium paid at the end of each year (P), and the death benefit (B), collected at the time when the life settler dies. For simplicity a flat yield curve is assumed, with a discount rate of a prevailing interest rate (r). The valuation is based on a life expectancy of t years.

V(sls)=−P*{(1/((1+r)¹)+(1/(1+r)²)+ . . . +(1/(1+r)^{t})}+(B/(1+r)^{t}) Equation (1)

Equation (1) can be re-written as follows:

V(sls)=−P*{(1/r)−(a^{t}/r)}+(B*a^{t})

where a=1/(1+r), and after re-arranging, equation (2) is obtained:

V(sls)=a^{t}*{(P/r)+B}−(P/r) Equation (2)

The first derivative of equation (2) relative to changes in t is as follows:

ΔV(sls)/Δt={(P/r)+B}*a^{t}*ln(a) Equation (3)

After multiplying the first derivative by t, dividing it by the value of the life settlement, the life extension duration is obtained:

life extension duration={t*a^{t}*(P+((r*B)*ln(a))}/{(a^{t}*(P+(r*B))) −P} Equation (4)

The result of the life extension duration is negative: The further beyond life expectancy a life settler lives, the less valuable the senior life settlement becomes. As the actual longevity of the life settler approaches or falls below life expectancy, the life settlement contracts increases.

The percentage change in value of a life settlement relative to changes in time, rather than relative to percentage changes in time, the modified-life extension duration is obtained by dividing the life extension duration by t:

modified-life extension duration={a^{t}*(P+(r*B))*ln(a)}/{i a^{t}*(P+(r*B))−P} Equation (5)

Investors in pools of senior life settlements can evaluate the pool's sensitivity to life extension (Δt) using the modified-life extension duration of the pool:

% ΔV(sls)={Δt*(a^{t}*(P+((r*B)*ln(a))}/{(a^{t}*(P+(r*B))−P} Equation (6)

The percentage change in value of the pool, % ΔV(sls), given a change in time due to life extension or reduction of Δt is equal to the pool's modified-life extension duration, multiplied by the life extension or reduction Δt. For example, for a life extension of two years, Δt=2, the percentage change in the value of the pool % ΔV(sls) will be equal to:

% ΔV(sls)={2*(a^{t}*(P+(r*B)*ln(a))}/{a^{t}*(P+(r*B))−P} Equation (7)

The life extension convexity is obtained by taking the second derivative of the value of senior life settlement and by dividing it by the value of the senior life settlement:

δ²V(sls)/δt²={((P/r)+B)*a^{t}*(ln(a))²}/{(a^{t}*((P/r)+B))−(P/r)} Equation (8)

This convexity is positive, which means that as the actual life of a settler declines the value of the settlement contract increases at an increasing rate. A positive convexity indicates that as actual life or longevity increases the value of the life settlement contract would decline at an increasing rate.

The weighted average modified life extension duration, weighted average modified-life extension duration, is obtained by multiplying each life settlement's duration by its corresponding value, dividing it by the value of the entire pool, and summing up the results for each of the n life settlements, as shown in equation (9):

$${\sum }_{i = 1}^{n} ( {V ( sls )}_{i} / V ( pool ) ) * {( modified \text{-} life extension duration )}_{i} \qquad Equation ( 9 )$$

wherein n is the number of variable term securities, and where

$$V ( pool ) = {\sum }_{i = 1}^{n} ( {V ( sls )}_{i}$$

wherein n is the number of variable term securities.

The weighted average life extension convexity, weighted average life extension convexity, is obtained by multiplying each life settlement's convexity by its corresponding value, dividing it by the value of the entire pool, and summing up the results for each of the n life settlements, as shown in equation (10):

$$= {\sum }_{i = 1}^{n} ( {V ( sls )}_{i} / V ( pool ) ) * {( life extension convexity )}_{i} \qquad Equation ( 10 )$$

wherein n is the number of variable term securities.

Investors buying securities backed by a pool of life settlements will have information on the weighted average life expectancy of the pool. The modified life extension duration and the life extension convexity provide information on how sensitive the value of the pool is to deviations around life expectancy of the pool. This is critical information to investors who purchase securities collateralized by the pool of life settlement contracts.

These methods are equally applicable to all financial instruments with an uncertain number of periods. The method is readily embodied in electronic systems for the computation of the factor, and further for the display of the factor or alternatively to automate financial trading on the basis of comparison of such factors.

The methods described herein apply to viatical settlements, which were introduced in the early 1990s. People who held life insurance policies who fell victim to terminal diseases and had a life expectancy of no more than two to three years (so-called viators) could sell their life insurance policies at a discount from face value to different companies, who in turn would securitize them (as viaticals). Viaticals lost their popularity when, particularly, viators affected with AIDS experienced extension in their life with the development of new drugs and drug treatments.

In another aspect, the invention relates to a system for computing and displaying a method of evaluating a variable term security or a plurality of variable term securities. The system comprises (a) a computer having a memory and a processor, wherein the memory comprises an algorithm for calculation of a summary factor of life extension risk of a variable term security or an aggregate factor of life extension risk of a plurality of variable term securities, (b) a monitor display in communication with the computer for dynamically displaying one or more summary factors of life extension risk or aggregate factors of life extension risk, and (c) an input in communication with the computer for inputting variables related to the variable term security or plurality of variable term securities.

In yet another aspect, the invention is a system for electronic trading of variable term securities, the system comprising a plurality of computer terminals and a data network or data networks, wherein the plurality of computer terminals are in communication with the data network or data networks, and wherein the plurality of computer terminals are adapted to display at least one of (i) a summary factor of life extension risk or an aggregate factor of life extension risk of the variable term securities, (ii) comparison of the summary factor or aggregate factors to a predetermined criterion, and (iii) the result of a comparison of the summary factor or aggregate factors to a predetermined criterion.

In yet another aspect, the invention is a system for automatic electronic trading of variable term securities, the system comprising:

a trade execution mechanism and a computer, the computer comprising a processor and a memory, the memory comprising;

a summary factor of life extension risk or aggregate factor of life extension risk;

an investor criterion for selecting a variable term security or plurality of variable term securities; and

an algorithm for deciding to trade or not to trade a variable term security or a plurality of variable term securities based at least in part on comparison of the summary factor of life extension risk or the aggregate factor of life extension risk to the investor criterion.

The invention will be illustrated in more detail with reference to the following Example, but it should be understood that the present invention is not deemed to be limited thereto.

### EXAMPLE

Before analyzing a pool of senior life settlements, a life settlement with the following characteristics is selected:

Face Amount=$10,000,000

Yearly Premium=$500,000

Life Expectancy=4

Using Equations (5) and (8), the modified-life extension duration (column 2) and the life extension convexity (column 3) for a range of discount rates (column 1) was calculated as shown in Table 1.

TABLE 1

| r % | mod t-dur | t-convexity |
|---|---|---|
| 0.03 | (0.0996732597) | 0.00295 |
| 0.04 | (0.1120340279) | 0.00439 |
| 0.05 | (0.1243863681) | 0.00607 |
| 0.06 | (0.1367343440) | 0.00797 |
| 0.07 | (0.1490820432) | 0.01009 |
| 0.08 | (0.1614335819) | 0.01242 |
| 0.09 | (0.1737931096) | 0.01498 |
| 0.10 | (0.1861648150) | 0.01774 |
| 0.11 | (0.1985529305) | 0.02072 |
| 0.12 | (0.2109617379) | 0.02391 |
| 0.13 | (0.2233955737) | 0.02730 |
| 0.14 | (0.2358588349) | 0.03090 |
| 0.15 | (0.2483559848) | 0.03471 |

The interpretation of Table 1 is as follows: the value of the life settlement with a $10 million in face value, a $500,000 yearly premium, and with a life expectancy of four years, will decrease by 12.43% for a discount rate of 5% if the life settler lives one year above life expectancy. The value will decrease by twice that percentage if the life settler lives two year above life expectancy. In each case, one would have to add back to the new value obtained from the modified-life extension duration, the percentage change in value due to convexity. This is due to the curvature of the price/life expectancy curve of senior life settlements.

The percentage change in value due to the life extension convexity is computed using equation (11) as follows:

{(½)*((P/r)+B)*a^{t}*(ln(a))²}/{((a^{t}*((P/r)+B))−(P/r))*(Δt)²} Equation (11)

In Table 2, the initial value of the senior life settlement was calculated over a range of discount rates using equation (1). This is shown in column (2). Still using equation (1), the value of the senior life settlement was calculated for a shift by two years above the initial life expectancy of 4 years. This is shown in column (3). Finally, in column (4), rather than using equation (1), the modified-life extension duration was used, from equation (5), and the life extension convexity, from equation (8), to compute the value of the senior life settlement that lives two years above life expectancy.

TABLE 2

| | value | | value estimated Δt = +2 |
|---|---|---|---|
| | at nominal life | value computed | using duration and convexity |
| r | expectancy | at Δt = +2 | factors |
| 0.03 | 7026321.278 | 5666246.845 | 5667050.794 |
| 0.04 | 6733094.298 | 5282076.829 | 5283594.115 |
| 0.05 | 6454049.496 | 4924307.933 | 4926795.019 |
| 0.06 | 6188383.826 | 4590943.241 | 4594664.795 |
| 0.07 | 5935346.492 | 4280152.408 | 4285375.322 |
| 0.08 | 5694235.108 | 3990256.437 | 3997245.022 |
| 0.09 | 5464392.172 | 3719713.974 | 3728726.141 |
| 0.10 | 5245201.830 | 3467108.951 | 3478393.223 |
| 0.11 | 5036086.897 | 3231139.434 | 3244932.654 |
| 0.12 | 4836506.111 | 3010607.550 | 3027133.177 |
| 0.13 | 4645951.614 | 2804410.380 | 2823877.264 |
| 0.14 | 4463946.621 | 2611531.719 | 2634133.283 |
| 0.15 | 4290043.275 | 2431034.612 | 2456948.368 |

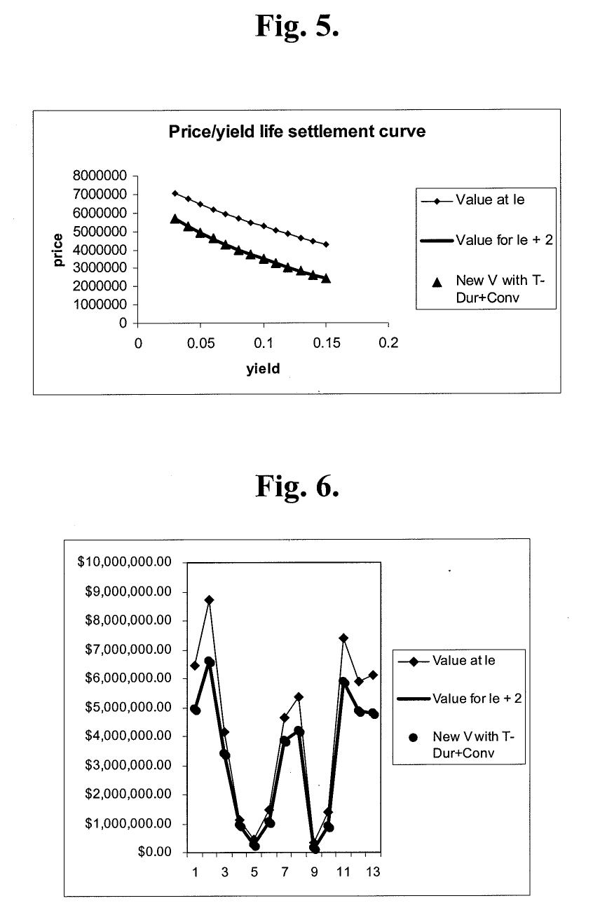

Columns (2), (3) and (4) were presented in FIG. 5. It was observed that the downward shift (leftward) in the price/life expectancy (value/duration) curve of the life settlement due to the increase in life by two years above the life settler's nominal life expectancy, is exactly the same weather computed with equation (1), (column 3), or with the combination of equations (5) and (8), (column 4). Columns (3) and (4) exactly overlap in FIG. 5.

In Table 3 below, a pool of thirteen senior life settlements was analyzed, with different face amounts, annual premium payments and life expectancies, for a total of $82,000,000 in face value and a yield of 5%.

TABLE 3

| | | | | | | | | value |
|---|---|---|---|---|---|---|---|---|
| | | | | | | | | estimated |
| | | | value at | | | | | using |
| face | annual | | nominal | computed | | life | | duration |
| amount | premium | life | life | value for | % dV for | extension | | and |
| (MM) | (k) | expectancy | expectancy | Δt = +2 | Δt = +2 | convexity | (½)Conv(dt)\hat{ }2 | convexity |
| 10 | 500 | 4 | $6,454,049 | $4,924,307 | −0.2370 | 0.00607 | 0.0121376626 | 4,926,795 |
| 15 | 700 | 5 | $8,722,258 | $6,609,758 | −0.2422 | 0.00620 | 0.0124027242 | 6,613,193 |
| 5 | 200 | 2 | $4,163,265 | $3,404,322 | −0.1823 | 0.00467 | 0.0093352162 | 3,405,556 |
| 2 | 50 | 7 | $1,132,043 | $933,826 | −0.1751 | 0.00448 | 0.0089665921 | 934,149 |
| 1 | 75 | 5 | $458,815 | $276,703 | −0.3969 | 0.01016 | 0.0203259132 | 276,999 |
| 3 | 150 | 6 | $1,477,292 | $1,061,036 | −0.2818 | 0.00721 | 0.0144292432 | 1,061,712 |
| 6 | 200 | 3 | $4,638,375 | $3,835,261 | −0.1731 | 0.00443 | 0.0088666733 | 3,836,567 |
| 8 | 350 | 4 | $5,340,537 | $4,193,230 | −0.2148 | 0.00550 | 0.0110012917 | 4,195,096 |
| 1 | 100 | 5 | $350,578 | $132,043 | −0.6234 | 0.01596 | 0.0319215548 | 132,399 |
| 4 | 200 | 8 | $1,414,714 | $911,306 | −0.3558 | 0.00911 | 0.0182222174 | 912,124 |
| 10 | 450 | 3 | $7,412,914 | $5,886,997 | −0.2058 | 0.00527 | 0.0105412296 | 5,889,478 |
| 7 | 250 | 2 | $5,884,353 | $4,872,429 | −0.1720 | 0.00440 | 0.0088064004 | 4,874,074 |
| 10 | 400 | 5 | $6,103,471 | $4,792,263 | −0.2148 | 0.00550 | 0.0110012917 | 4,794,395 |

The weighted average modified-life extension duration, weighted average modified life extension duration, is obtained by multiplying each life settlement's duration by its corresponding value, dividing it by the value of the entire pool, and summing up the results for each of the n life settlements (13 in this example), as previously shown in Equation (9).

The weighted average life extension convexity, weighted average life extension convexity, is obtained by multiplying each life settlement's convexity by its corresponding value, dividing it by the value of the entire pool, and summing up the results for each of the n life settlements (13 in our example), as previously shown in equation (10):

Inventors found that the weighted average modified life extension duration for the pool of thirteen life settlements was equal to −0.11484, and that the weighted average life extension convexity was equal to 0.00560.

These values may be used to make an investment decision. For instance, a potential investor may have established a criterion not to invest if the modified life extension duration is less than −0.1. The value of −0.11484 obtained for the pool in the example is more risky, and would not be traded.

The total initial value of our pool corresponds to $53,552,671.03, and for a life extension of two years above life expectancy, the new value of the pool is obtained as follows:

$$\begin{matrix} \begin{matrix}value at life \\ expectancy + 2\end{matrix} = \$53 \text{,} 552 \text{,} 671.03 \\ \{ 1 - ( 0.11484 * ( 2 ) ) + ( ( 0.5 ) * \\ ( 0.00560 ) * ( {( 2 )}^{2} ) ) \} \\ = \$41 \text{,} 852 \text{,} 541.76 .\end{matrix}$$

This value corresponds to the sum of the results in column (9) in exhibit 4.

In FIG. 6, columns (4), (5) and (9) from Table 3 were graphed. It was observed that the change in value of each of the thirteen life settlements in the pool, due to the increase in life by two years above the life settler's life expectancy, is exactly the same whether computed with equation (1), (column 5), or with the combination of equations (5) and (8), (column 9). Columns (5) and (9) exactly overlap as shown in FIG. 6. The value of the thirteen life settlements for nominal life expectancy (column (4), is the top curve.

While the invention has been described in detail and with reference to specific examples thereof, it will be apparent to one skilled in the art that various changes and modifications can be made therein without departing from the spirit and scope thereof.

### REFERENCES

A. M. Best, “Life Settlement Securitization”, Sep. 1, 2005.
Ballotta Laura and Haberman Steven, “The fair valuation problem of guaranteed annuity options: The stochastic mortality environment case”, Insurance: Mathematics and Economics, February 2006.
Bhattacharga Jay, Goldman Dana, Sood Neeraj, “Price Regulation in Secondary Insurance Markets”, The Journal of Risk and Insurance, 2004, Vol. 71, No. 4, 643-675.
D. Blake, A. J. G. Cairns and K. Dowd, “Living With Mortality: Longevity Bonds And Other Mortality-Linked Securities”, Presented to the Faculty of Actuaries, 16 Jan. 2006.
Cowley, Alex; Cummins, J. David, “Securitization of Life Insurance Assets and Liabilities”, Journal of Risk and Insurance, June 2005, v. 72, iss. 2, pp. 193-226.
Dowd Kevin, Cairns Andrew J. G. and Blake David, “Mortality-dependent financial risk measures”, Insurance: Mathematics and Economics, Volume 38, Issue 3, Pages 427-642 (15 Jun. 2006).
Lin, Yijia and Cox, Samuel H., “Securitization of Mortality Risks in Life Annuities”, Journal of Risk and Insurance, June 2005, v. 72, issue. 2, pp. 227-52.
Stone Charles A. and Zissu Anne, “Securitization of Senior Life Settlements: Managing Extension Risk”, The Journal of Derivatives, Spring 2006.

What is claimed is:

1. A method of evaluating a variable term security, the method comprising assessing life extension risk of the variable term security due to a deviation from nominal life expectancy of the variable term security;
computing a summary factor of said life extension risk; and
comparing the summary factor of said life extension risk to a predetermined criterion and thereby evaluating the variable term security.

2. The method of claim 1, wherein the summary factor of the life extension risk is at least one of a life extension duration, a modified life extension duration, or a life extension convexity.

3. The method of claim 2, the method comprising:
obtaining the nominal life expectancy of the variable term security (t);
obtaining a periodic premium of the variable term security (P);
obtaining a terminal benefit of the variable term security (B);
obtaining a prevailing interest rate (r); and
setting a compounding factor (a) according to the formula:
a=1/(1+r).

4. The method of claim 3 wherein the life extension duration is computed by applying the formula:
life extension duration={t*a^{t}*(P+(r*B)*ln(a)}/{(a^{t}*(P+(r*B)))−P}.

5. The method of claim 3 wherein the change in the value of a variable term security is computed by multiplying the life extension duration by the deviation from life expectancy (Δt).

6. The method of claim 3 wherein the modified life extension duration is computed by applying the formula:
modified life extension duration={a^{t}*(P+(r*B))*ln(a)}/{(a^{t}*(P+(r*B)))−P}.

7. The method of claim 3 wherein the life extension convexity is computed according to the formula:
life extension convexity={((P/r)+B)*(a^{t})*((ln(a))²)}/{(a^{t}*((P/r)+B))−(P/r)}.

8. The method of claim 1 further comprising deciding to trade or not to trade the variable term security based at least in part upon a comparison of the summary factor of life extension risk to the predetermined criterion.

9. The method of claim 1 further comprising: computing an aggregate factor of life extension risk for the plurality of variable term securities by aggregating the summary factor of life extension risk of each variable term security.

10. The method of claim 9, wherein the aggregate factor of the life extension risk is at least one a weighted average life extension duration, a weighted average modified life extension duration, or a weighted average life extension convexity.

11. The method of claim 10, the method comprising:
obtaining the nominal life expectancy of each variable term security (t);
obtaining the periodic premium of the each variable term security (P);
obtaining the terminal benefit of the each variable term security (B);
obtaining the prevailing interest rate (r);
setting the compounding factor a=1/(1+r);
computing the nominal value of the variable term security (V(sls)) according to the formula:
V(sls)={a^{t}*((P/r)+B)}−(P/r); and
computing the nominal value of a pool of (n) variable term securities (V(pool)) according to the formula:
$${\sum }_{i = 1}^{n} ( {V ( sls )}_{i}$$
wherein n is the number of variable term securities.

12. The method of claim 12 wherein the weighted average modified life extension duration is computed for the plurality of variable term securities according to the formula:
$${\sum }_{i = 1}^{n} ( {V ( sls )}_{i} / V ( pool ) ) * {( modified life extension duration )}_{i}$$
wherein n is the number of variable term securities.

13. The method of claim 12 wherein the weighted average life extension convexity is computed for the plurality of variable term securities according to the formula:
$${\sum }_{i = 1}^{n} ( {V ( sls )}_{i} / V ( pool ) ) * {( life extension convexity )}_{i}$$
wherein n is the number of variable term securities.

14. A system for computing and displaying a method of evaluating a variable term security or a plurality of variable term securities, the system comprising:
a computer having a memory and a processor, wherein the memory comprises an algorithm for calculation of a summary factor of life extension risk of a variable term security or an aggregate factor of life extension risk of a plurality of variable term securities;
a monitor display in communication with the computer for dynamically displaying one or more summary factors of life extension risk or aggregate factors of life extension risk; and
an input in communication with the computer for inputting variables related to the variable term security or plurality of variable term securities.

15. A system for electronic trading of variable term securities, the system comprising a plurality of computer terminals and a data network or data networks, wherein the plurality of computer terminals are in communication with the data network or data networks, and wherein the plurality of computer terminals are adapted to display at least one of (i) a summary factor of life extension risk or an aggregate factor of life extension risk of the variable term securities, (ii) comparison of the summary factor or aggregate factors to a predetermined criterion, and (iii) the result of a comparison of the summary factor or aggregate factors to a predetermined criterion.

16. A system for automatic electronic trading of variable term securities, the system comprising:
a trade execution mechanism and a computer, the computer comprising a processor and a memory, the memory comprising;
a summary factor of life extension risk or aggregate factor of life extension risk;
an investor criterion for selecting a variable term security or plurality of variable term securities; and
an algorithm for deciding to trade or not to trade a variable term security or a plurality of variable term securities based at least in part on comparison of the summary factor of life extension risk or the aggregate factor of life extension risk to the investor criterion.
